(19) United States
(12) Patent Application Publication
(10) Pub. No.: US 2015/0111164 A1
(43) Pub. Date: Apr. 23, 2015

(54) CERAMIC SUBSTRATE, FIRING SETTER, AND MANUFACTURING METHOD OF CERAMIC SUBSTRATE USING THE SAME

(71) Applicant: Samsung Electro-Mechanics Co., Ltd., Suwon-si (KR)

(72) Inventors: Seung Wook Park, Suwon-si (KR); Jang Su Kim, Suwon-si (KR); No Il Park, Suwon-si (KR); Doo Sung Jung, Suwon-si (KR)

(73) Assignee: Samsung Electro-Mechanics Co., Ltd., Suwon-si (KR)

(21) Appl. No.: 14/199,090

(22) Filed: Mar. 6, 2014

(30) Foreign Application Priority Data
Oct. 17, 2013 (KR) 10-2013-0124023

(51) Int. Cl. F27D 5/00; C04B 35/64

(52) U.S. Cl. CPC F27D 5/00; C04B 35/64
USPC 432/258; 264/671; 428/141

(57) ABSTRACT

Disclosed herein are a ceramic substrate, a firing setter, and a manufacturing method of a ceramic substrate using the same. According to the present invention, there is provided a ceramic substrate including: a first substrate concave-convex part formed on a lower surface thereof and having a first substrate roughness; and a second substrate concave-convex part formed on an upper surface thereof and having a second substrate roughness.

### CROSS REFERENCE TO RELATED APPLICATION

This application claims the benefit of Korean Patent Application No. 10-2013-0124023, filed on Oct. 17, 2013, entitled “Ceramic Substrate, Firing Setter, and Manufacturing Method of Ceramic Substrate Using the Same”, which is hereby incorporated by reference in its entirety into this application.

### BACKGROUND OF THE INVENTION

1. Technical Field

The present invention is relates to a ceramic substrate, a firing setter, and a manufacturing method of a ceramic substrate using the same.

2. Description of the Related Art

A substrate for mounting an electronic device has been widely used in an electronic device field, or the like. Responding to demand for miniaturization, lightness, multi-function, and high reliability of electronic devices, and the like, a ceramic substrate has been suggested to thereby be practically used.

The ceramic substrate is formed by laminating a plurality of ceramic green sheets. A wiring conductor, an electronic component, or the like, is formed integrally with each of the ceramic green sheets laminated in plural, such that densification of a circuit board may be achieved.

The ceramic substrate as described above may be formed by laminating the plurality of green sheets to form a laminate body and firing the laminated body (EP Patent Laid-Open Publication No. 01094694).

### SUMMARY OF THE INVENTION

The present invention has been made in an effort to provide a ceramic substrate capable of suppressing warpage using roughness, a firing setter, and a manufacturing method of a ceramic substrate using the same.

According to a preferred embodiment of the present invention, there is provided a ceramic substrate including: a first substrate concave-convex part formed on a lower surface thereof and having a first substrate roughness; and a second substrate concave-convex part formed on an upper surface thereof and having a second substrate roughness, wherein the first substrate roughness and the second substrate roughness are different from each other.

The first substrate concave-convex part may have a plurality of first substrate roughnesses.

At least one of the plurality of first substrate roughnesses may have a different value.

The second substrate concave-convex part may have a plurality of second substrate roughnesses.

At least one of the plurality of second substrate roughnesses may have a different value.

According to another preferred embodiment of the present invention, there is provided a firing setter including: a lower setter including a first setter concave-convex part formed on an upper surface thereof and having a first setter roughness; and an upper setter positioned over the lower setter, and including a second setter concave-convex part formed on a lower surface thereof and having a second setter roughness, wherein the first setter roughness and the second setter roughness are different from each other.

The first setter concave-convex part may have a plurality of first setter roughnesses.

At least one of the plurality of first setter roughnesses may have a different value.

The second setter concave-convex part may have a plurality of second setter roughnesses.

At least one of the plurality of second setter roughnesses may have a different value.

According to another preferred embodiment of the present invention, there is provided a manufacturing method of a ceramic substrate, the manufacturing method including: preparing a firing setter including a lower setter including a first setter concave-convex part formed on an upper surface thereof and having a first setter roughness, and an upper setter positioned over the lower setter, and including a second setter concave-convex part formed on a lower surface thereof and having a second setter roughness, the first setter roughness and the second setter roughness being different from each other; mounting a ceramic green sheet in the firing setter; and firing the ceramic green sheet.

In the firing of the ceramic green sheet, a lower surface of the fired ceramic green sheet may be formed with a first substrate concave-convex part corresponding to the first setter concave-convex part.

In the firing of the ceramic green sheet, an upper surface of the fired ceramic green sheet may be formed with a second substrate concave-convex part corresponding to the second setter concave-convex part.

In the preparing of the firing setter, the first setter concave-convex part may have a plurality of first setter roughnesses.

At least one of the plurality of first setter roughnesses may have a different value.

In the preparing of the firing setter, the second setter concave-convex part may have a plurality of second setter roughnesses.

At least one of the plurality of second setter roughnesses may have a different value.

### BRIEF DESCRIPTION OF THE DRAWINGS

The above and other objects, features and advantages of the present invention will be more clearly understood from the following detailed description taken in conjunction with the accompanying drawings, in which:

FIG. 1 is an exemplary diagram showing a ceramic substrate according to a first preferred embodiment of the present invention;

FIG. 2 is an exemplary diagram showing a ceramic substrate according to a second preferred embodiment of the present invention;

FIG. 3 is an exemplary diagram showing a ceramic substrate according to a third preferred embodiment of the present invention;

FIG. 4 is an exemplary diagram showing a firing setter according to the preferred embodiment of the present invention; and

FIGS. 5 to 7 are exemplary diagrams showing a manufacturing method of a ceramic substrate using a firing setter according to the preferred embodiment of the present invention.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

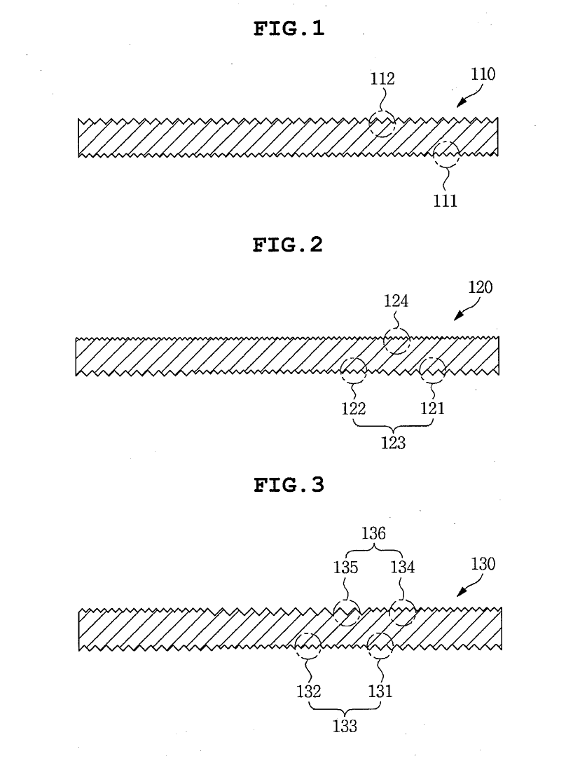

FIG. 1 is an exemplary diagram showing a ceramic substrate according to a first preferred embodiment of the present invention.

A lower surface of the ceramic substrate 110 according to the first preferred embodiment of the present invention may be formed with a first substrate concave-convex part 111. The first substrate concave-convex part 111 may have a first substrate roughness.

In addition, an upper surface of the ceramic substrate 110 may be formed with a second substrate concave-convex part 112. The second substrate concave-convex part 112 may have a second substrate roughness.

Here, a first substrate roughness value and a second substrate roughness value may be different from each other.

That is, the upper and lower surfaces of the ceramic substrate 110 according to the preferred embodiment of the present invention may be formed so as to have different roughnesses from each other.

The ceramic substrate 110 may be formed by firing a ceramic green sheet. Although the case in which a single layer ceramic substrate 110 is formed is described in the present invention, the present invention is not limited thereto. The ceramic substrate 110 may be formed by laminating a plurality of ceramic green sheets. In addition, a conductive pattern such as a circuit pattern, via, and the like, may be formed on the ceramic green sheet. In addition, the ceramic substrate 110 according to the preferred embodiment of the present invention may have a thin thickness of 150 μm or less.

Both surfaces of the ceramic substrate 110 according to the preferred embodiment of the present invention may be formed with substrate concave-convex parts having different substrate roughnesses from each other. Stress applied to the ceramic substrate 110 may be different according to the substrate roughness. In addition, a warpage direction and a warpage degree of the ceramic substrate 110 may be different according to the stress applied thereto. Therefore, according to the preferred embodiment of the present invention, in the ceramic substrate 110, warpage may be decreased by adjusting the substrate roughnesses of both surfaces thereof.

FIG. 2 is an exemplified diagram showing a ceramic substrate according to a second preferred embodiment of the present invention.

The ceramic substrate 120 may be formed by firing a ceramic green sheet. Although the case in which a single layer ceramic substrate 120 is formed is described in the present invention, the present invention is not limited thereto. The ceramic substrate 120 according to the preferred embodiment of the present invention may be formed by laminating a plurality of ceramic green sheets and have a thin thickness of 150 μm or less. The ceramic substrate 120 may have a thickness of 150 μm or less, and a thickness at which warpage may be generated at the time of performing a firing process.

One surface of the ceramic substrate 120 according to the second preferred embodiment of the present invention may be formed with a substrate concave-convex part having a plurality of substrate roughnesses.

For example, a lower surface of the ceramic substrate 120 may be formed with a substrate concave-convex part having two substrate roughnesses, and an upper surface thereof may be formed with a substrate concave-convex part having one substrate roughness.

The lower surface of the ceramic substrate 120 may be formed with a first substrate concave-convex part 123. The first substrate concave-convex part 123 may have a plurality of first substrate roughnesses. For example, the first substrate concave-convex part 123 may include a 1-1th substrate concave-convex part 121 and a 1-2th substrate concave-convex part 122. The 1-1th substrate concave-convex part 121 may have a 1-1th substrate roughness and the 1-2th substrate concave-convex part 122 may have a 1-2th substrate roughness. Here, the 1-1th substrate concave-convex part 121 may be formed at outer regions of the upper surface of the ceramic substrate 120, which are both sides of the 1-2th substrate concave-convex part 122.

In addition, the upper surface of the ceramic substrate 120 may be formed with a second substrate concave-convex part 124. The second substrate concave-convex part 124 may have a second substrate roughness.

Here, at least one of a 1-1th substrate roughness value, a 1-2th substrate roughness value, and a second substrate roughness value may be different.

Although the case in which the lower surface of the ceramic substrate 120 has a plurality of roughnesses is described by way of example, but one surface formed with the plurality of roughnesses is not limited to the lower surface.

FIG. 3 is an exemplified diagram showing a ceramic substrate according to a third preferred embodiment of the present invention.

The ceramic substrate 130 may be formed by firing a ceramic green sheet. Although the case in which a single layer ceramic substrate 130 is formed is described in the present invention, the present invention is not limited thereto. The ceramic substrate 130 may be formed by laminating a plurality of ceramic green sheets. In addition, a conductive pattern such as a circuit pattern, via, and the like, may be formed on the ceramic green sheet. In addition, the ceramic substrate 130 according to the preferred embodiment of the present invention may have a thin thickness of 150 μm or less.

Both surfaces of the ceramic substrate 130 according to the third preferred embodiment of the present invention may be formed with a substrate concave-convex part having a plurality of substrate roughnesses.

For example, both surfaces of the ceramic substrate 130 may be formed with a substrate concave-convex part having two substrate roughnesses.

The lower surface of the ceramic substrate 130 may be formed with a first substrate concave-convex part 133. The first substrate concave-convex part 133 may have a plurality of first substrate roughnesses. For example, the first substrate concave-convex part 133 may include a 1-1th substrate concave-convex part 131 and a 1-2th substrate concave-convex part 132. The 1-1th substrate concave-convex part 131 may have a 1-1th substrate roughness and the 1-2th substrate concave-convex part 132 may have a 1-2th substrate roughness. Here, the 1-1th substrate concave-convex part 131 may be formed at outer regions of the lower surface of the ceramic substrate 130.

In addition, the upper surface of the ceramic substrate 130 may be formed with a second substrate concave-convex part 136. The second substrate concave-convex part 136 may have a plurality of second substrate roughnesses. For example, the second substrate concave-convex part 136 may include a 2-1th substrate concave-convex part 134 and a 2-2th substrate concave-convex part 135. The 2-1th substrate concave-convex part 134 may have a 2-1th substrate roughness and the 2-2th substrate concave-convex part 135 may have a 2-2th substrate roughness. Here, the 2-1th substrate concave-convex part 134 may be formed at outer regions of the upper surface of the ceramic substrate 130.

Here, at least one of a 1-1th substrate roughness value, a 1-2th substrate roughness value, a 2-1th substrate roughness value, and a 2-2th substrate roughness value may be different.

Both surfaces of the ceramic substrate 130 according to the preferred embodiment of the present invention may be formed with substrate concave-convex parts having two substrate roughnesses, respectively. However, the number of roughness formed on both surfaces of the ceramic substrate 130 is not limited to 2, but the substrate concave-convex parts having different numbers of substrate roughnesses from each other may be formed on both surfaces.

According to the preferred embodiment of the present invention, different stress may be applied to each of portions of the ceramic substrate 130 by forming the substrate concave-convex part having various substrate roughnesses on the ceramic substrate. Therefore, a warpage portion of the ceramic substrate 130 and a warpage degree at each portion may be delicately adjusted, such that warpage may be effectively decreased.

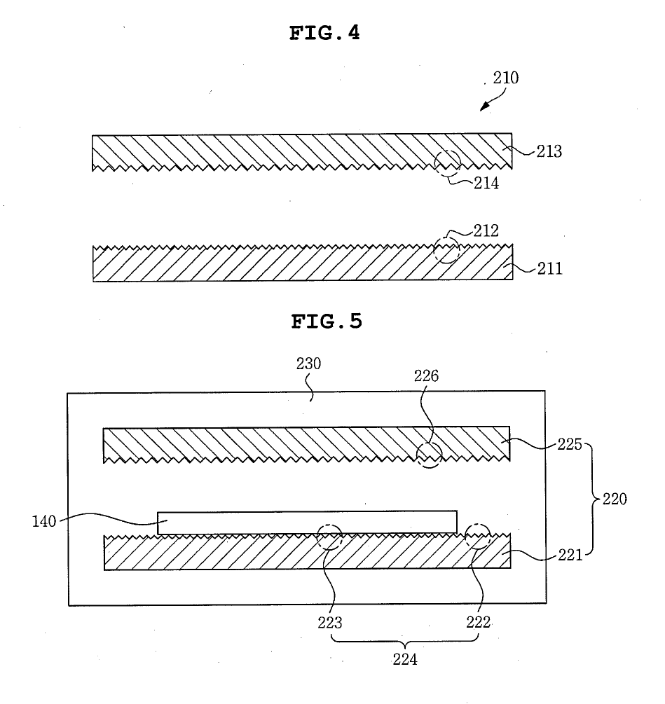

FIG. 4 is an exemplary diagram showing a firing setter according to the preferred embodiment of the present invention.

A firing setter 210 is an apparatus for firing a ceramic green sheet in order to form a ceramic substrate (not shown). The firing setter 210 may be positioned in a firing furnace and press and support the ceramic green sheet during a firing process.

The firing setter 210 according to the preferred embodiment of the present invention may include a lower setter 211 and an upper setter 213.

An upper surface of the lower setter 211 may be formed with a first setter concave-convex part 212. The first setter concave-convex part 212 may be formed so as to have a first setter roughness. Although the case in which the first setter concave-convex part 212 of the lower setter 211 has a single first setter roughness is described in the preferred embodiment of the present invention, the present invention is not limited thereto. That is, the first setter concave-convex part 212 of the lower setter 211 may be formed so as to one or more first setter roughness.

The upper setter 213 may be positioned over the lower setter 211. A lower surface of the upper setter 213 may be formed with a second setter concave-convex part 214. Here, the lower surface of the upper setter 213 and the upper surface of the lower setter 211 may be positioned so as to face each other. That is, the first and second setter concave-convex parts 212 and 214 may face each other. The second setter concave-convex part 214 may be formed so as to have a second setter roughness. A second setter roughness value may be different from a first setter roughness value. Although the case in which the second setter concave-convex part 214 of the upper setter 213 has a single second setter roughness is described in the preferred embodiment of the present invention, the present invention is not limited thereto. That is, the second setter concave-convex part 214 of the upper setter 213 may be formed so as to have one or more second setter roughness.

In the preferred embodiment of the present invention, the numbers, values, and positions of setter roughnesses of the lower and upper setters 211 and 213 may be variously changed according to a warpage portion and a warpage degree of a ceramic substrate (not shown) formed by a firing process.

When the ceramic green sheet is fired by the firing setter 210, warpage may be generated after firing by pressure, a temperature, or the like, in the ceramic substrate (not shown). The firing setter 210 according to the preferred embodiment of the present invention may be formed using a property of the ceramic substrate (not shown) warped according to the substrate roughness That is, the first and second setter concave-convex parts 212 and 214 of the firing setter 210 may be formed so that the ceramic substrate (not shown) has a substrate roughness capable suppressing warpage generate at the time of firing.

FIGS. 5 to 7 are exemplary diagrams showing a manufacturing method of a ceramic substrate using a firing setter according to the preferred embodiment of the present invention.

Referring to FIG. 5, a ceramic green sheet 140 may be mounted in a firing setter 220.

The firing setter 220 may be positioned in a firing furnace 230 and press and support the ceramic green sheet 140 during the firing process.

The firing setter 220 according to the preferred embodiment of the present invention may include a lower setter 221 and an upper setter 225.

An upper surface of the lower setter 221 may be formed with a first setter concave-convex part 224. The first setter concave-convex part 224 may be formed so as to have a plurality of first setter roughnesses.

For example, a 1-1th setter concave-convex part 222 having a 1-1th setter roughness may be formed on the lower setter 211. In addition, a 1-2th setter concave-convex part 223 having a 1-2th setter roughness may be formed on the lower setter 221. The 1-1th setter concave-convex part 222 may be formed at both sides of the 1-2th setter concave-convex part 223.

The upper setter 225 may be positioned over the lower setter 221. A lower surface of the upper setter 225 may be formed with a second setter concave-convex part 226. Here, the lower surface of the upper setter 225 and the upper surface of the lower setter 221 may be positioned so as to face each other. The second setter concave-convex part 226 may be formed so as to have a second setter roughness.

In the preferred embodiment of the present invention, a 1-1th setter roughness value, a 1-2th setter roughness value, and a second setter roughness value may be different from each other. In addition, the 1-1th setter roughness value, the 1-2th setter roughness value, and the second setter roughness value may be values at which warpage generated at each portion at the time of firing the ceramic green sheet 140 may be suppressed.

The firing setter 220 as described above may be positioned in the firing furnace 230 in which the firing process is performed.

The ceramic green sheet 140 may be mounted in the firing setter 220. The ceramic green sheet 140 may be positioned between the lower and upper setters 221 and 225.

In the preferred embodiment of the present invention, the ceramic green sheet 140 may be formed of a single layer. However, the ceramic green sheet 140 is not limited to the single layer. The ceramic green sheet 140 may have a multilayer structure or a structure in which a plurality of ceramic green sheets are laminated. In addition, a conductive pattern such as a circuit pattern, via, and the like, may be formed on the ceramic green sheet 140.

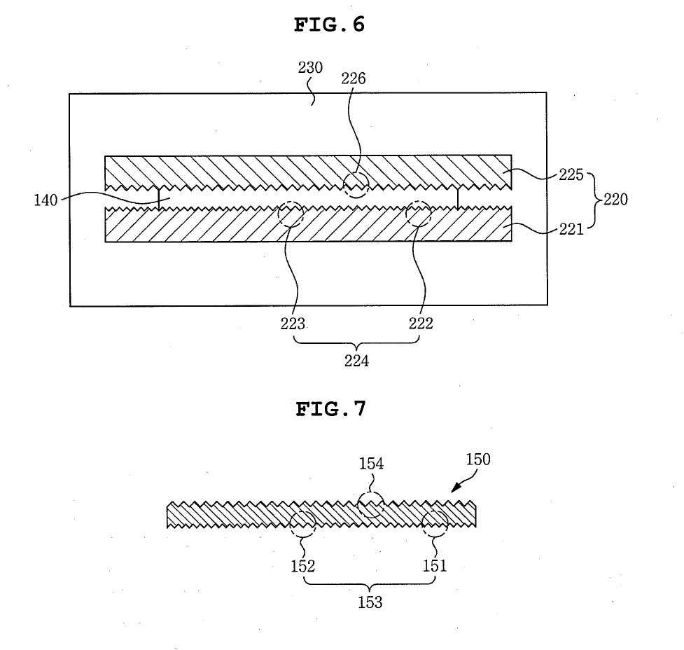

Referring to FIG. 6, the ceramic green sheet 140 may be fired.

An internal temperature of the firing furnace 230 becomes a firing temperature, such that the firing process may be performed. When the firing process proceeds in the firing furnace 230, the firing setter 220 may press the mounted ceramic green sheet 140. The ceramic green sheet 140 may become a ceramic substrate (150 of FIG. 7) through the firing process as described above. In addition, the ceramic substrate 150 according to the preferred embodiment of the present invention may have a thin thickness of 150 μm or less.

FIG. 7 shows the ceramic substrate 150 formed through the firing process.

In the ceramic substrate 150 according to the preferred embodiment of the present invention, a concave-convex part may be formed by the firing setter (220 of FIG. 6). That is, at the time of the firing process, the setter concave-convex part formed in the firing setter (220 of FIG. 6) may be transcribed as it is on both surfaces of the ceramic green sheet (140 of FIG. 6).

An lower surface of the ceramic substrate 150 may be formed with a first substrate concave-convex part 153 corresponding to the first setter concave-convex part (224 of FIG. 6). That is, the lower surface of the ceramic substrate 150 may be formed with a 1-1th substrate concave-convex part 151 corresponding to the 1-1th setter concave-convex part (222 of FIG. 6). The 1-1th substrate concave-convex part 151 may be formed so as to have a 1-1th substrate roughness value equal to the 1-1th setter roughness value. In addition, the lower surface of the ceramic substrate 150 may be formed with a 1-2th substrate concave-convex part 152 corresponding to the 1-2th setter concave-convex part (223 of FIG. 6). The 1-2th substrate concave-convex part 152 may be formed so as to have a 1-2th substrate roughness value equal to the 1-2th setter roughness value.

In addition, the upper surface of the ceramic substrate 150 may be formed with a second substrate concave-convex part 154 corresponding to the second setter concave-convex part (226 of FIG. 6). The second substrate concave-convex part 154 may be formed so as to have a second substrate roughness value equal to the second setter roughness value.

According to the preferred embodiment of the present invention, the concave-convex part capable of suppressing warpage may be transcribed on the ceramic green sheet (140 of FIG. 6) by the firing setter (220 of FIG. 6) at the time of the firing process. Therefore, stress capable of suppressing warpage is applied to each portion of the ceramic green sheet (140 of FIG. 6), such that the ceramic substrate 150 of which warpage is suppressed may be formed after the firing process is terminated.

The roughnesses, the positions, and the numbers of concave-convex parts formed on the firing setter (220 of FIG. 6) and the ceramic substrate 150 according to the preferred embodiment of the present invention may be variously implemented by those skilled in the art.

According to the prior art, in the case of forming a ceramic substrate having a thin thickness of 150 μm or less, the thinner the thickness is, the further the warpage is generated. However, according to the preferred embodiment of the present invention, at the time of forming the ceramic substrate, warpage generation may be prevented in spite of the thin thickness by allowing the upper and lower surfaces of the ceramic substrate to have different roughnesses from each other.

The ceramic substrate, the setter, and the manufacturing method of a ceramic substrate using the setter according to the preferred embodiment of the present invention may suppress the warpage of the ceramic substrate by forming the roughness.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A ceramic substrate comprising:
a first substrate concave-convex part formed on a lower surface thereof and having a first substrate roughness; and
a second substrate concave-convex part formed on an upper surface thereof and having a second substrate roughness,
wherein the first substrate roughness and the second substrate roughness are different from each other.

2. The ceramic substrate as set forth in claim 1, wherein the first substrate concave-convex part has a plurality of first substrate roughnesses.

3. The ceramic substrate as set forth in claim 2, wherein at least one of the plurality of first substrate roughnesses has a different value.

4. The ceramic substrate as set forth in claim 1, wherein the second substrate concave-convex part has a plurality of second substrate roughnesses.

5. The ceramic substrate as set forth in claim 4, wherein at least one of the plurality of second substrate roughnesses has a different value.

6. A firing setter comprising:
a lower setter including a first setter concave-convex part formed on an upper surface thereof and having a first setter roughness; and
an upper setter positioned over the lower setter, and including a second setter concave-convex part formed on a lower surface thereof and having a second setter roughness,
wherein the first setter roughness and the second setter roughness are different from each other.

7. The firing setter as set forth in claim 6, wherein the first setter concave-convex part has a plurality of first setter roughnesses.

8. The firing setter as set forth in claim 7, wherein at least one of the plurality of first setter roughnesses has a different value.

9. The firing setter as set forth in claim 6, wherein the second setter concave-convex part has a plurality of second setter roughnesses.

10. The firing setter as set forth in claim 9, wherein at least one of the plurality of second setter roughnesses has a different value.

11. A manufacturing method of a ceramic substrate, the manufacturing method comprising:
preparing a firing setter including a lower setter including a first setter concave-convex part formed on an upper surface thereof and having a first setter roughness, and an upper setter positioned over the lower setter, and including a second setter concave-convex part formed on a lower surface thereof and having a second setter roughness, the first setter roughness and the second setter roughness being different from each other;
mounting a ceramic green sheet in the firing setter; and
firing the ceramic green sheet.

12. The manufacturing method as set forth in claim 11, wherein in the firing of the ceramic green sheet, a lower surface of the fired ceramic green sheet is formed with a first substrate concave-convex part corresponding to the first setter concave-convex part.

13. The manufacturing method as set forth in claim 11, wherein in the firing of the ceramic green sheet, an upper surface of the fired ceramic green sheet is formed with a second substrate concave-convex part corresponding to the second setter concave-convex part.

14. The manufacturing method as set forth in claim 11, wherein in the preparing of the firing setter, the first setter concave-convex part has a plurality of first setter roughnesses.

15. The manufacturing method as set forth in claim 14, wherein at least one of the plurality of first setter roughnesses has a different value.

16. The manufacturing method as set forth in claim 11, wherein in the preparing of the firing setter, the second setter concave-convex part has a plurality of second setter roughnesses.

17. The manufacturing method as set forth in claim 16, wherein at least one of the plurality of second setter roughnesses has a different value.
